(19) United States
(12) Patent Application Publication
(10) Pub. No.: US 2007/0194051 A1
(43) Pub. Date: Aug. 23, 2007

(54) Cellular tanks for storage of fluid at low temperatures

(76) Inventors: Kare Bakken, Aros (NO); Pal Bergan, Nesoya (NO)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/698,906

(22) Filed: Jan. 29, 2007

Related U.S. Application Data
(63) Continuation-in-part of application No. 11/629,813, now abandoned.

(30) Foreign Application Priority Data
Jun. 25, 2004 (NO) 20042702

(51) Int. Cl. B67D 5/64

(52) U.S. Cl. 222/173

(57) ABSTRACT

The invention regards a tank for storing of fluid at very low temperature, as LNG, which tank comprises external plates, forming roof, side walls and floor, and an internal cell structure with fluid communication between all the cells in the cell structure at floor level of the tank. At least a part of the external plate comprises a layered structure and where the internal cell structure is formed as self equilibrating support and or anchoring for the external plates. The invention also regards a cell structure for use in a tank for storing fluid.

### RELATED APPLICATIONS

This application is a continuation-in-part of U.S. application Ser. No. ______, filed Dec. 18, 2006, which is a §371 of International Application No. PCT/NO2005/000232, filed Jun. 27, 2005 and claims priority of Norwegian Application No. 20042702, filed Jun. 25, 2004, the contents of all of which are incorporated herein by reference.

The present invention relates to a tank for storing of fluid, preferably fluids at low temperatures, a sandwich structure for use in a tank and a method for producing a tank.

There is a need for storage of Liquefied Natural Gas (LNG) at cryogenic temperature and near atmospheric pressure in all areas of the LNG value chain:
a) Fixed and floating offshore production facilities (liquefaction facility)
b) Onshore production and storage facilities
c) Waterborne transportation on ships
d) Fixed and floating offshore import terminal and possible re-gasification facilities
e) Onshore import terminals and re-gasification facilities

Offshore production facilities and import terminals are representing new areas in the LNG chain and several projects and concepts are currently being investigated. For floating production facilities and import terminals the tanks will experience different degrees of filling rates which may represent a problem to some tank systems. Due to the wave induced motions of the structure, waves and dynamic motion of the fluid will develop inside a partially filled tank giving high dynamic pressures on the tank structure. This important effect called sloshing may represent a structural problem to most of the existing tank concepts.

For offshore production facilities, the shape of the tank is important as the tanks normally would be located inside the structure with the processing equipment located on the deck above the tanks. Prismatic tanks are preferred as they give the best utilisation of the volume available for the tanks. Another aspect which is important for the offshore production facilities is the fabrication and installation of the tanks. Prefabricated tanks which can be transported to the construction site in one piece or a low number of pieces offers reduced overall construction time and by that reduced cost. A fully prefabricated tank can also be leakage tested prior to the installation. The construction of a membrane tank systems is complicated and need to be done on the construction site inside a finished structure giving a construction time of typically 12 months, or more.

For waterborne transport on ships, two main tank systems are dominating the market; the Moss spherical tank system and the membrane tank systems developed by GTT (Gaz Transport et Technigaz, France). The self-supporting SPB tank developed by IHI (Ishikawajima-Harima Heavy Industries Co., Ltd., Japan) is yet another possible system. The maximum size of LNG ships delivered today are in the range 138 000-145 000 m³ while the market demands now ships in the range 200 000-250 000 m³. These ship sizes may represent a design challenge for the existing tank systems. Long construction time is one of the main problems for the existing tank systems. Typically construction time for a 145 000 m³ LNG ship is around 20 months or more with the construction and testing of the tank systems as the dominating bottleneck. A new challenge for the tank systems is introduced in connection with planned offshore loading and unloading giving a need to design the tanks for partially filling and associated dynamic sloshing pressures.

The Moss spherical tank concept was initially developed during 1969-1972 using aluminium as the cryogenic material. The design is an independent tank with a partial secondary barrier. The insulation is normally plastic foam applied to the outer surface of the tank wall. For ships and offshore facilities the spherical tank concept has relative low utilising of a restricted volume and it is not suited for having the possibility to have a flat deck on offshore facilities.

The development of the membrane tank systems was started in 1962 and has been further developed by Technigaz. Today the systems consists of a thin stainless steel or Invar steel primary barrier, an insulation layer of Perlite filled plywood boxes or plastic foam, an Invar steel or Triplex secondary barrier and finally a secondary layer of insulation. The stainless steel membranes are corrugated in order to handle the thermal contraction and expansion of the membrane while the Invar steel membrane does not need any corrugation. With respect to construction, the system is rather complicated with a lot of specialized component and a substantial amount of welding. The welding of the membranes and the corrugations give variations in stress concentrations and stress variations due to sloshing all with associated possible cracking due to fatigue, give a potential high risk for leakages. Liquid sloshing due to wave induced motions of the vessel for partially filled tanks is a limitation for these tanks; typically no fillings between 10% and 80% are allowed in seagoing conditions. Sloshing generally gives very high dynamic pressures on the interior tank walls, particular in corner areas, which may cause damage to the membrane and underlying insulation. Another concern is that inspection of the secondary barrier is not possible.

The SPB tank developed by IHI is an independent prismatic tank with a partial secondary barrier designed as a traditional orthogonally stiffened plate and frame system. The system consists of plates and a stiffening system consisting of stiffeners, frames, girders, stringers and bulkheads as in a traditionally designed ship structure. Due to these structural elements, sloshing is not considered to be a problem. Fatigue may have been considered to be a problem for this tank system due to the significant amount of details and local stress concentrations. Insulation is attached to the outer surface of the tank and the tank rests on a system of wooden block supports.

Mobil Oil Corporation has developed a box-like polygonal tank for storing of LNG on land or on ground based structures, described in patent application PCT/US99/22431. The tank is comprised of an internal, truss-braced, rigid frame having a cover on the frame for containing the stored liquid within the tank. The internal, truss-based frame allows the interior of the tank to be contiguous throughout to sustain the dynamic loads caused by the sloshing of stored liquid which is due to the short excitation caused by seismic activity. The tank is prefabricated in sections and assembled on site. The tank structure has a number of details and stress concentrations which is a consideration with respect to fatigue life.

From U.S. Pat. No. 3,978,808 is it known a double wall cargo tank for transporting cryogenics, in which tank the stiffeners are arranged so as to enable automatic welding techniques to be employed. In the double wall tank the secondary barrier is supported by the stiffeners. Further, the insulation means acts as a support for the liquid and gas impervious secondary barrier.

For onshore import terminals and re-gasification facilities, the market is dominated by cylindrical tanks constructed as single containment, full containment or double containment tanks. A single containment tank comprises an inner tank and an outer container. The inner tank is made of cryogenic material, usually 9% Ni steel, and is normally a cylindrical wall with flat bottom. Pre-stressed concrete and aluminium has also been used for the inner tanks. The outer container is generally made of carbon steel which only has the function of keeping the insulation in place and does not provide significant protection in the event of a failure of the inner tank.

The majority of LNG storage tanks built recently around the world is designed as double or full containment tanks. In these designs, the outer tank is designed to contain the full amount of the inner tank in case of a failure of the inner tank. For full containment tanks, the outer tank or wall is normally constructed as a prestressed concrete wall distanced 1-2 m from the inner tank with insulation material in the spacing. Traditionally built onshore LNG tanks are expensive, have a construction time of about 1 year and have to be built on the location requiring substantial local infrastructure.

Purpose

The main purpose of the present invention is to provide a new type of highly efficient, self-carrying low temperature tank which may have a hexahedral or prismatic shape and which is fully scalable; that is, the tank is in principle extendable to any dimensions or size while being based on mainly a repetitive structural principle. It is also an aim that the tank concept can withstand a large member of cycles of pressure and temperature variations during its lifetime.

A further purpose is to achieve a tank with a high volume efficiency; that is, for the tank volume to be able to fill out as much as possible of surrounding spaces that typically are segmented in hexahedral, rectangular or prismatic volumes (e.g. cargo holds in ships, containment spaces on floating platforms, segmented spaces at land-based plants, etc.).

An additional feature and purpose is to provide a tank system which solves the problem of internal fluid sloshing for tanks that are onboard ships or floating installations.

A further aim is to provide a thermally insulated self-carrying tank that can be prefabricated in parts or in total and that can be transported and positioned into final location and position.

Another aim is to provide a low temperature tank that has enhanced operational capabilities in terms of improved fatigue performance, design life and ease of inspection.

A further aim is to develop a tank system that is economically and technically competitive with current tank systems for similar use.

A further purpose of the current invention is to provide a self-contained system of a tank or a cell structure that can be prefabricated in one location and transported and placed in another location, e.g. onboard ships, floating terminals or sites on land.

The tank can extensively be equipped for its operational purpose including filling and discharge system, monitoring systems etc.

General part

These aims are achieved with the invention as defined in the following claims.

The invention regards a prismatic or hexahedral tank or containment system for storage of fluids at very low temperatures. The external tank comprising side walls, floor and roof, at least some of these elements comprise a plate structure which serves the purpose of being the structural element and provide leak tightness for the tank. In an embodiment the plate structure may also as well as provide required thermal insulation or part of the thermal insulation of the tank. The plate structure (plate) comprises a layered structure, which at least comprises a sandwich. By sandwich one should in this application understand at least two layers bonded or connected to each other by a core and transferring loads between the layers. One special embodiment of such a sandwich comprising two layers with a core between, is one where an outer layer may be formed with a multitude of throughgoing recesses, which recesses further are covered by a membrane material.

The external plate structure in the walls are anchored by way of a self-equilibrating, normally thin, internal cell structure wall system that effectively anchor the external walls against the static and dynamic loads which they are exposed to in a normal position of the tank. This will however not be achieved under other conditions, for instance by rolling of ships, where different power distributions pictures will be formed.

In a preferred embodiment the layered plate structure comprises the sandwich structure, which comprises at least two surface sheets of metal or other material with similar properties with a core material in between. The core of the sandwich may be a continuous material or a structure comprising of different shaped webs, forming cells with a direction mainly parallel with the sheets in between the two sheets. This internal structure may also be a honeycomb or other similar structure between the sheets. The main element is that the core of the sandwich, transfer loads between the two sheets in the sandwich. Additional insulation may be provided at the outside and or inside of this sandwich structure. Having this sandwich structure with two sheets and a core structure also gives the benefit of the possibility to have a gas detection arrangement in between the two sheets in the sandwich.

The tank may have different prismatic forms; however, the typical geometry is a hexahedral or “box-like” shape. The external side walls or side plates and the bottom floor or plate are exposed to static and dynamic fluid pressures and are designed to withstand such loads. A metal sheet or plate in the sandwich structure provides the necessary bending strength in relation to the core, which may be a structure or a material that mainly serve the purpose of transferring shear forces. The core of the sandwich may provide a part of the insulation of the tank, this may for instance be due to having a material with very low thermal conductivity forming at least a part of the core material or structure. Sufficient strength and stiffness of the external plate may also be provided by way of extra stiffeners.

The external walls are effectively anchored at vertical intersection lines with the internal cell structure walls and must essentially transfer the loads in plate action to these supports. Similarly the bottom plate may comprise a layered structure, preferably a sandwich structure, that is exposed to fluid pressure as well as own weight. The bottom plate or floor essentially transfers these loads to suitably located supporting means, for instance at grid points of the internal cell structure wall system. These support means, which provide for a relative thermal motion in relation to the foundation, will be described later. The internal cell structure walls are primarily stressed in their own plane in horizontal direction due to the pressure loads transferred from the external walls. In the case of tanks located on land the internal cell structure walls may be very thin plates dimensioned according to the principle of “fully stressed design”. Very thin plates may be difficult to handle, a way of improving this wall will be explained later. In cases of tanks on moving foundation the internal cell structure walls will also have to be designed for dynamic loads from the fluid stored.

In case of sandwich construction the core material in the external plate parts of the tank serves the dual function of partly thermal insulation and structural stiffness; it must have strength and thickness sufficiently large to serve these purposes. In one embodiment most of the thermal insulation may be performed by the core of the sandwich structure.

In one embodiment where the core is in the form of a continuous material layer various types of materials may be applied for the core as long as they have suitable properties in terms of stiffness, strength, thermal conductivity and thermal expansion (contraction) coefficient. Typically the material mix may consist of fine grain components and larger granular components submerged in a matrix material. The fine grain components may be various types of sand or various inorganic or organic materials. The larger components are typically porous grains that provide strength and insulation at low weight. Such aggregates may be expanded glass, it may be burnt and expanded clay, or it may be other types of geo-materials or organic materials such as plastics. Some examples of commercial aggregate materials are Perlite, Liaver, Liapor, Leca, etc. An alternative to light weight aggregates is introducing air or gas bubbles into the matrix material before binding. The binder or matrix material may be one or several of typical binder materials such as cement paste, silica, polymers, or any other material that would serve well in the current context. Special chemical components may also be added to the paste in order to achieve special properties such as desired viscosity, shrinkage reduction or volume control, right speed of hardening, fatigue performance etc. Metallic, inorganic or organic fibres may also be added to the mix to achieve higher strength, particularly in tension.

The core layer may as said also be provided by a structure formed by webs between the two sheet layers forming different shaped cells between the sheets, which cells has a longitudinal direction mainly parallel with the sheets. There may be webs arranged mainly across in relation to the sheets, or at an angle other than 90 degrees in relation to the sheets, or forming more like a honeycomb structure.

There are several methods for producing the sandwich structure in the external plates of the tank according to the preferred embodiment. The core material may in the form of a continuous material either be placed in fluid form directly between sheets that make out the formwork for the casting the core. Alternatively the core material may in part be prefabricated as plates or blocks that are grouted or glued to the sheets and to each other. The core may consist of different layers of glued plate material through the thickness. The material may also vary from one part of the plates to the other.

In the other version of the sandwich structure it may be extruded as a whole structure with both sheets and core in one, or the core element may be extruded and welded to the sheets of the sandwich structure. The core element may also be formed by several separate elements welded together to form the core element.

In another version of the current invention the core material and dimensions primarily serve the purpose of necessary structural strength, and the additional, necessary thermal insulation is provided by a largely non-structural insulation layer at the outside of the “sandwich” structural part. In this case the core of the sandwich can be made of a relatively high strength material such as good quality concrete or a structure. In the example of a continuous core, the core material may for instance be a “high strength” concrete with compressive strength of 80 MPa and weight 2400 kg per m³. The additional insulation on the outside is then not exposed to forces of significance, and can be inexpensive insulation like rock-wool or glass-wool. In this case the sandwich part of the external barriers will be under nearly uniform temperature corresponding to the temperature of the internal fluid. This sandwich part of the wall will accordingly contract or expand in a rather uniform way. The insulation layer on the outside will host the main part of the temperature gradient, but will have no problem with accommodating the thermal deformation of the sandwich on the inside since it is a loose, non-structural material.

The inner skin of the sandwich layered structure of the external plates of the tank is typically made of a metal that has sufficient strength as well as resistance to the thermal and chemical environment of the fluid stored in the tank. It may also be formed by non-metallic materials with similar properties. In the case of a tank for LNG containment the material may be 9% Nickel steels or austenitic stainless steels like 304, 304L, 316, 316L, 321 or 347. Other types of metals, aluminium alloys or Invar steel, or composites may also be used. The outer skin is typically not exposed to the same harsh thermal and chemical environment as the inner skin, and it may be made of for instance a simpler type of carbon structural steel. For the inner as well as the outer skin applies that the material must be suitable for joining, such as welding, and have sufficiently good bonding properties to the core, be it a structure or a core material or to the binder of core blocks.

In the case of using a higher strength, but less insulating, core material the outer skin of the sandwich layer will also be exposed to nearly same thermal regime as the inner skin. In such case the outer skin must be an alloy that can maintain sufficient strength at the actual temperature regime.

The sandwich structure in the plates may comprise stiffeners, for improving the bonding between the elements in the sandwich and also for improving the structural strength of the sandwich. In one embodiment may the core material in itself give little structural strength to the sandwich structure, this may be achieved through stiffeners. The stiffeners may be of different forms but preferably they are plate like members having a width running from one surface sheet to the other surface sheet and a length running in the direction from e.g. the bottom to the top of the tank structure, preferably the whole way, or possibly as a grid structure. There may be a continuous material in between the grid structure or there may be voids and the grid structure then forms the core structure in the sandwich. A special case is that the external wall is made as a stiffened plate structure or a box structure rather than a sandwich plate. In such case, the insulation within or on the outside is not required to have structural properties.

The main components of the tank is the external plates, comprising side walls, a floor and a roof, that are insulated, layered plates, and a set of cellular internal walls that essentially are self-equilibrating support or anchor walls for the external plates.

The internal anchoring cell walls that make out the internal cellular structure must satisfy the same requirements as the inner sheet described earlier, i.e. they will typically be made of the same material. The internal anchoring cell walls may be formed in several ways, they may be plane sheets crossing each other forming cells, this cell structure may also be formed by corrugated sheets.

Another preferred embodiment is to form the internal cell structure by a plurality of beam elements stretching from one side wall to the opposite sidewall. The cell structure is build by arranging one beam transverse to the next beam positioned next to the first beam, where a third beam is positioned similar to the first beam transverse to the second beam and a fourth beam transverse to the third beam, and by this forming a lattice structure, which lattice structure comprises openings between the beams positioned above each other, i.e. the first, third, fifth beam and second fourth and sixth beam etc. Another way of explaining it would be to say that the beams form a sort of “log cabin” structure, with gaps between the different logs in the structure. The beams would preferably also run from one external wall to the opposite external wall of the tank.

The cell structure is in this embodiment formed such that in a plane A transverse to the side walls, all beams A are arranged with their longitudinal direction in the plane A and mainly parallel to each other. The beams arranged directly above these first beams A are all arranged in a second plane B where the beams have mainly parallel longitudinal axis. These planes A and B are repeated in an ABABABAB pattern until the necessary height of the cell structure is achieved. Other patterns are also possible, with for instance a third layer of beams.

The angle between the first and second beam may preferably be around 90 degrees forming rectangular or square cells, but it is also conceivable to have an arrangement where a crossing of beams form angles of 60/120 or other configuration.

The contact points where beams in one layer is crossing beams in another layer is preferably arranged in a straight line forming a position for transferring loads from for instance roof to floor construction of the tank.

The beams used in the beam arrangement may have several forms of their cross section, for instance T-shaped, I-shaped or only a rectangular or tubular shape. The flanges of the T or I shaped beams gives additional effects to avoid sloshing damages, by making turbulence in the flow of fluid as a consequence of movement of the tank. The flanges of the beams also support the cell structure by giving larger contact areas between the layers of beams the layered structure and gives rigidity in the contact position between the different layers of beams. These forms mentioned are standard forms for beams, other configurations of the cross section of a beam may also be possible, while achieving the same effect of anchoring of side walls, minimizing sloshing effects and at the same time having communication between the different cells in the structure

However, the internal cell structure may also be formed as a combination of the two above defined embodiments as particular constructional, environmentally and or safety circumstances would result in that these intermediate solutions are selected. This could, e.g. give a tank where the cell structure in the area round the tank floor is formed by a plurality of beam elements, after which it in the area above the beam elements are made use of sheets, so that the upper area again terminate by the beam elements.

For strength and for reasons of ease of production the intersections of the internal cell walls may include a separate member to which the wall segments are attached. This may be used for both plane plate cell walls and also a beam structure wall as described in the chapters above. For instance, this member may be a vertical beam of tubular or square cross-section. Since the internal cell walls themselves will be very thin (only a few millimetres), especially in the case of plate formed cell walls, it may in cases of applications where dynamic motion occurs be necessary to provide additional transverse strength. This may be done by attaching unilateral or two-sided horizontal stiffeners at suitable distance, or, alternatively, by providing lateral strength via horizontal corrugation of the thin internal wall plate. Note also that the mentioned tubular member at the intersections between inner wall segments essentially will have to carry the weight of the cell walls since these have nearly no vertical carrying capacity because of proneness to buckling due to high slenderness. The same tubular members will also have to carry the weight of the roof structure of the tank itself.

The sloshing phenomenon is strongly dependent on the size of the free surface area of the fluid volume, which, in the current invention is segmented into smaller areas by way of the cellular internal wall system. For instance, by using internal cells of 5 to 10 meters square the sloshing problem would, in most cases, be virtually eliminated. The internal cell walls would in such cases be subject to moderate fluid dynamic forces and should be designed for such purpose, e.g. by having a corrugation that provides required bending and shear force capacity, by having flanges on the beams. Similarly, the external plates, which comprise layered plates, preferably as a sandwich structure, are designed for fluid pressure loads which easily also may include moderate dynamic sloshing load components. It is a particular feature of the current invention that the sloshing problem is relatively independent of the degree of filling in the tank; in fact, the total fluid pressures will be reduced with lower degrees of filling.

Even though the internal volume is divided into separate cells there will in the case of plate cell walls be open holes at the bottom of the cell walls that equalize the fluid level in the cells and that give easy human access to all cells for inspection and repair purposes. For the beam structure cell walls, there are opening between the beams forming the walls giving communication. There may if necessary in addition be open holes close to the floor for human access. The important factor is to give communication between all the cells in the cell structure. These openings are positioned by the bottom floor and may have strengthening members associated with the opening edges.

The cellular grid of internal cell walls can be fully and uniformly exploited stress-wise and will typically be for plate cell walls very thin (a few millimetres) and for beam structure wall not be heavy. This is important since the internal plating often will have to be made of high grade, expensive alloys that can sustain the low temperatures and chemical environment of the internal fluid. Having very thin plates in the cell structure walls may as earlier mentioned cause a problem in handling the cell structure walls. The cell structure wall are therefore in one embodiment of the invention provided with cooperative end part elements at two opposite sides of the cell wall, which sides will meet another cell wall side at an intersection in the cell structure. These end part elements form together a stiffening member, stiffening the cell walls and also thereby the cell structure of the tank. For the beam cell wall structure the beams may preferably be formed with flanges for stiffening of the beams.

This gives a reasonable production and assembly of the cell structure. The layered sandwich construction of the external plates; side walls, floor and roof, serving both as structural and partly insulating elements, is economically very effective. Moreover, the internal as well as the external parts of the tank are fully modular and repetitive. This means that the tank leans itself to a very high degree of automation during its production. This in turn will also contribute toward favourable economic performance.

In one version of the invention the corners of the external walls may be rounded. One reason for introducing rounded corners is that one may obtain less concentrated structural moments in such case. Another reason may be to reduce somewhat thermal stressing between the two sides of the external walls.

The production method of the tank is important for practical reasons as well as for the overall economy. Pre-production in modules or in total implies reduced construction time and that tank production can go in parallel with construction of the rest of the vessel, platform or site where the tank is finally going to be located. The cellular tank system lends itself to prefabrication and automated production to an exceptionally high degree. All internal cell wall segments are essentially equal and can be mass produced “assembly line style”. Their attachment to the joining stiffening members can also be done in a repetitive and automated fashion. Highly effective welding techniques, such as friction stir welding, laser or plasma welding, may be considered in some cases. Also the outer plates may be produced segment-wise and joined together between themselves and with the internal cell walls.

A tank according to the invention will as described be able to be used for storage of different kind of fluid and will give good performance in the temperature range of +200° C. to −200° C., and especially suitable for LNG. The tank may withstand to have some bar static over pressure within the tank. It may be positioned on a floating unit or at a land based site.

The tank may be positioned on a bearing system, where one has one anchoring point and a means to prevent the tank form rotation. The tank may as an alternate also be positioned directly on a sand base or other base with similar properties.

The invention will now be explained with preferred embodiments with reference to the drawings where:

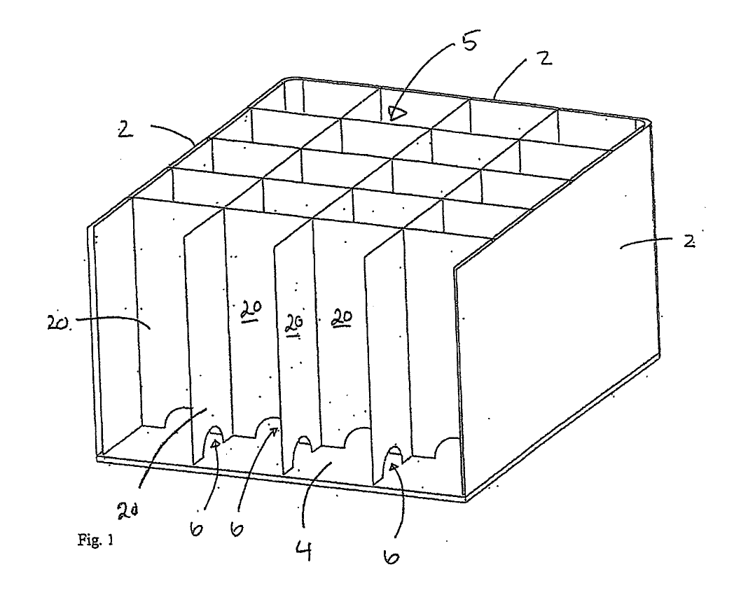

FIG. 1 shows a tank according to one overall embodiment of the invention with the roof and one side wall removed,

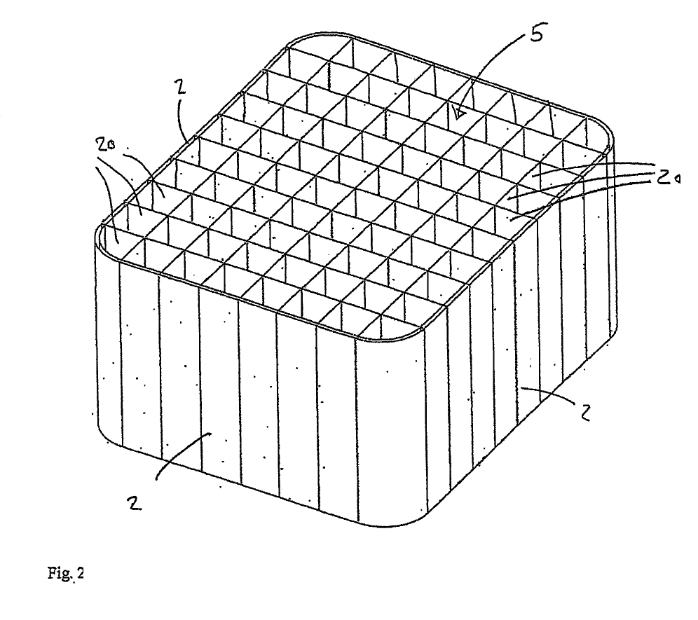

FIG. 2 shows a second overall embodiment of a tank according to the invention,

FIG. 3 shows a third overall embodiment of a tank according to the invention,

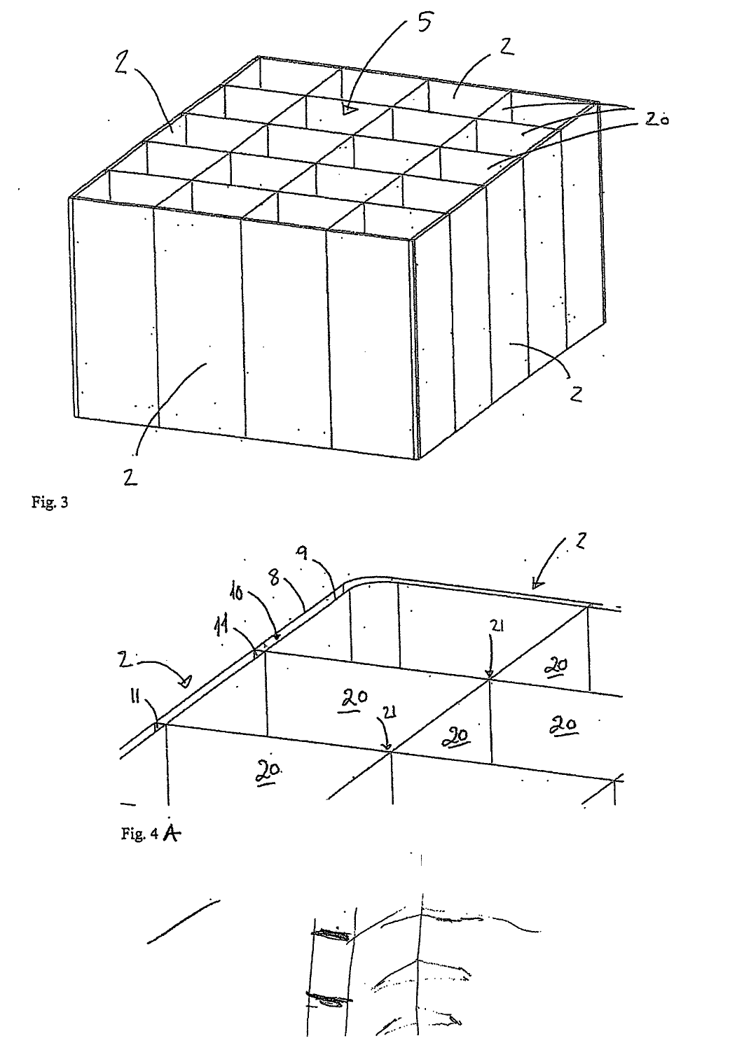

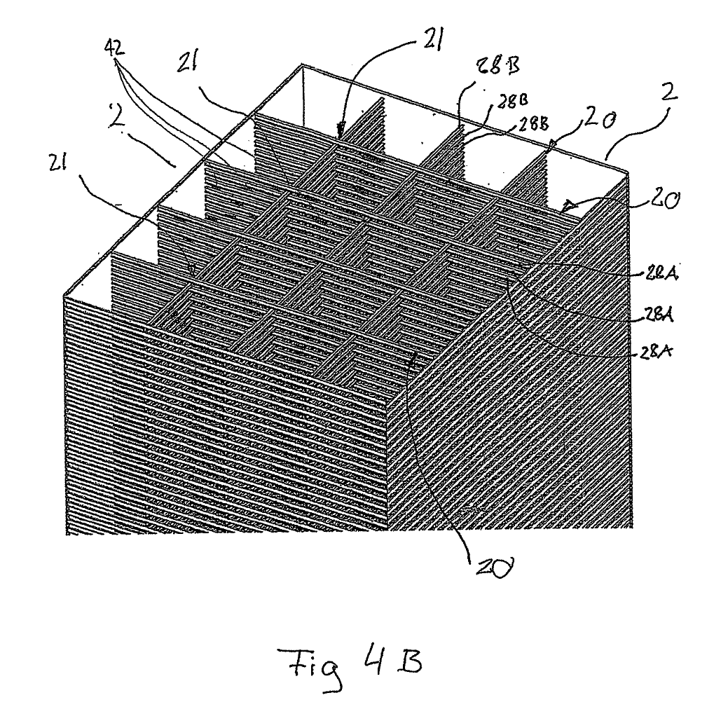

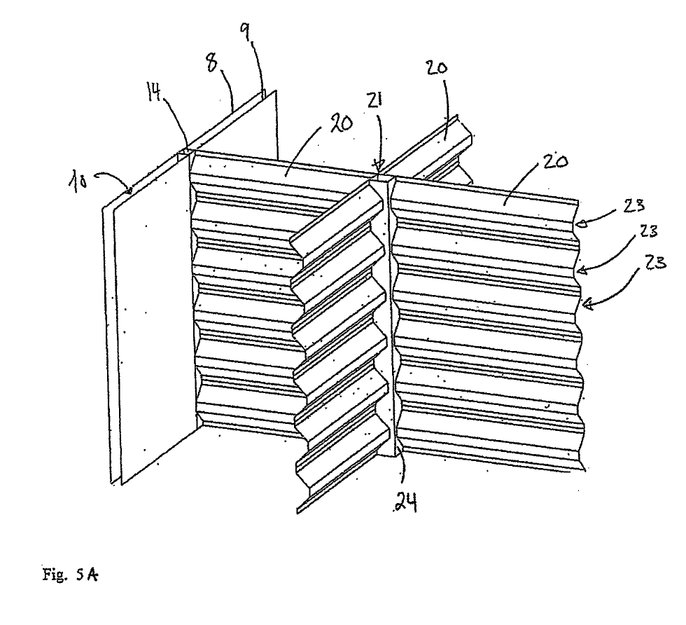

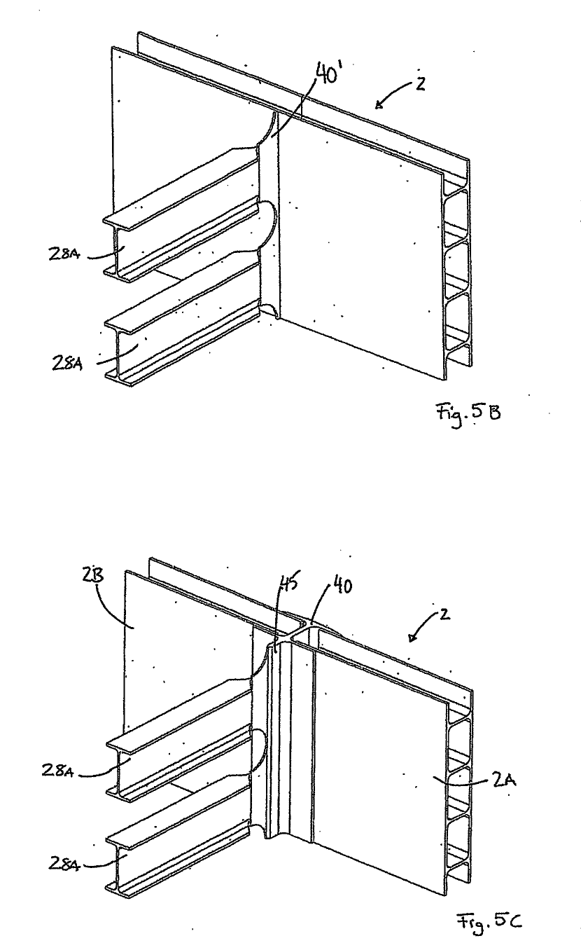

FIG. 4A and 4B show a detail of a corner of the tank in FIG. 1 with a first embodiment of an internal cell structure in FIG. 4A, and a second embodiment of the internal cell structure in FIG. 4B,

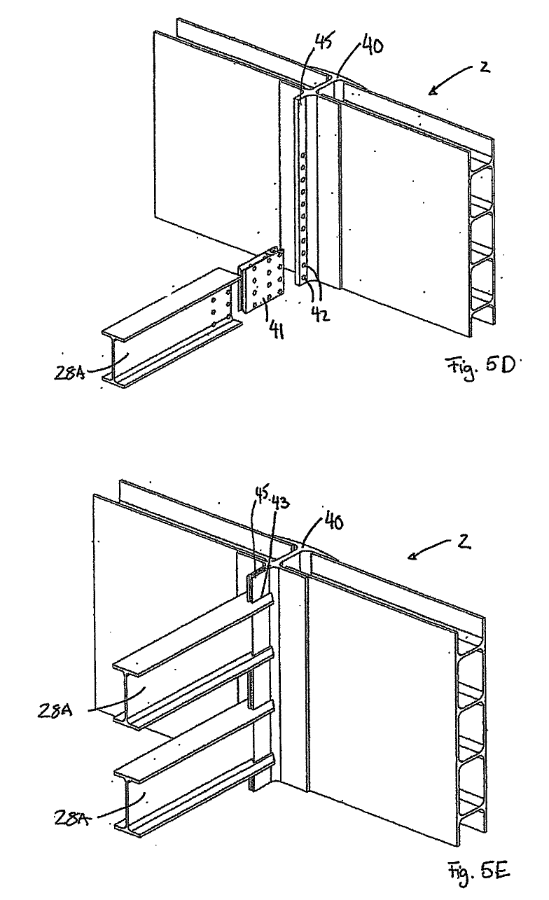

FIG. 5A shows a detail of a tank with a third embodiment of an internal cell wall structure attached to an external plate,

FIG. 5B-G show examples of details of the connection of a second and third embodiment of an internal cell wall structure to an external plate,

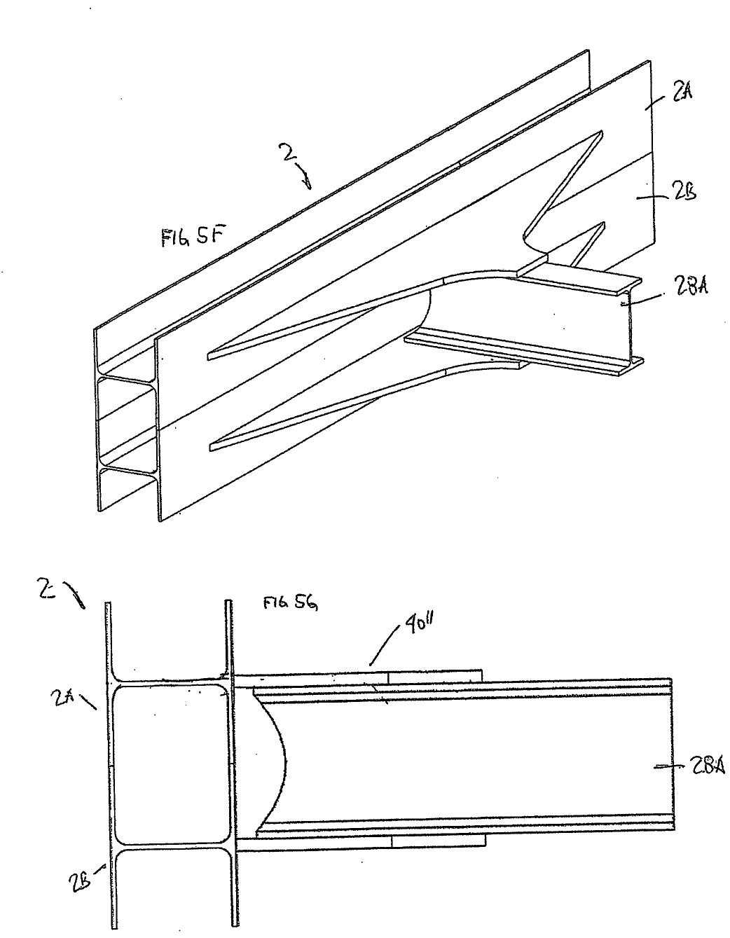

FIG. 6A shows a cross section of one embodiment of a cell wall in the first embodiment of cell structure,

FIG. 6B shows a cross section of an intersection of four cell walls according to the embodiment shown in FIG. 6A,

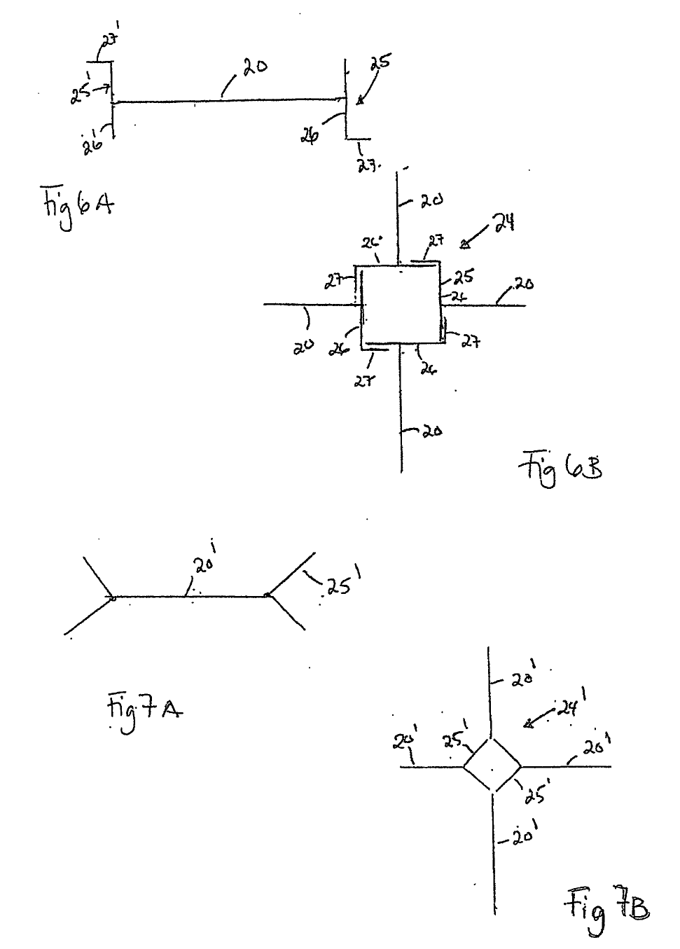

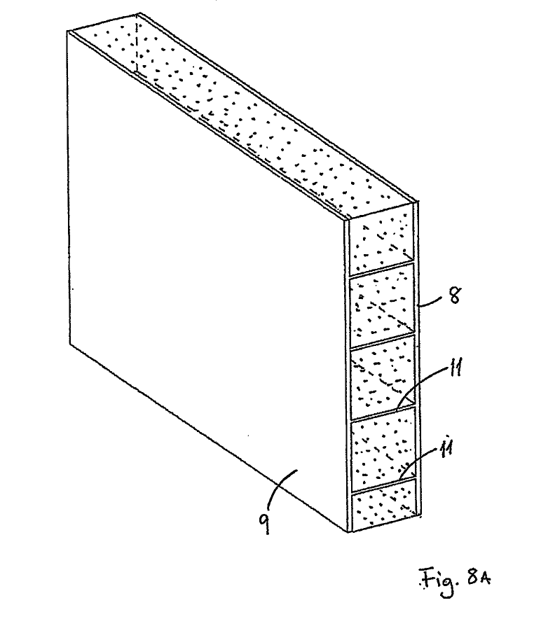

FIG. 7A shows a cross section of another embodiment of a cell wall in the first embodiment of cell structure,

FIG. 7B shows a cross section of an intersection of four cell walls according to the embodiment shown in FIG. 7A,

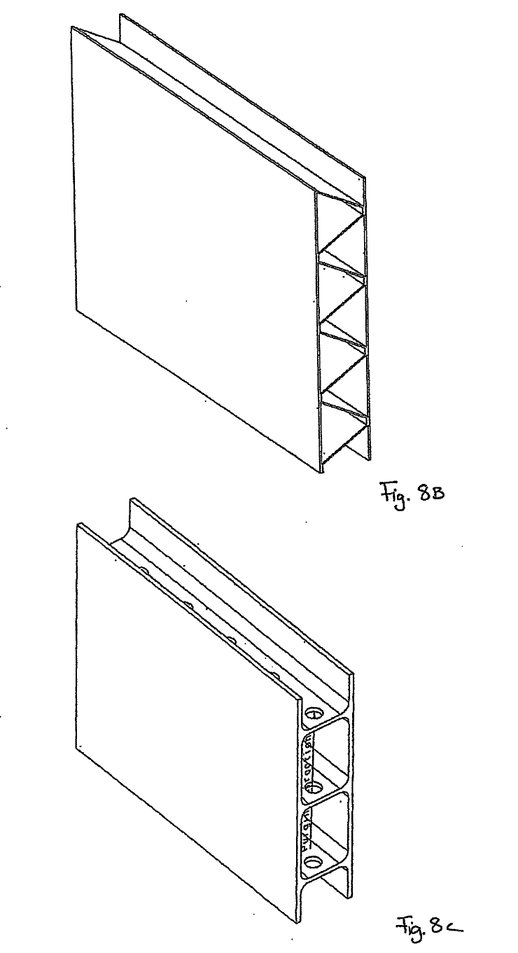

FIG. 8A-D show different cross sections of different embodiments of an external plate of a tank according to the invention,

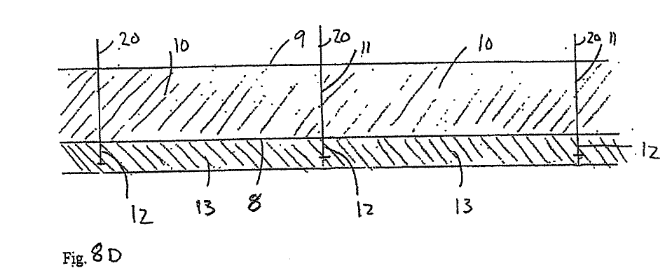

FIG. 9A-B show examples of different elevated view of alternative corner solutions of the external wall of a tank according to the invention,

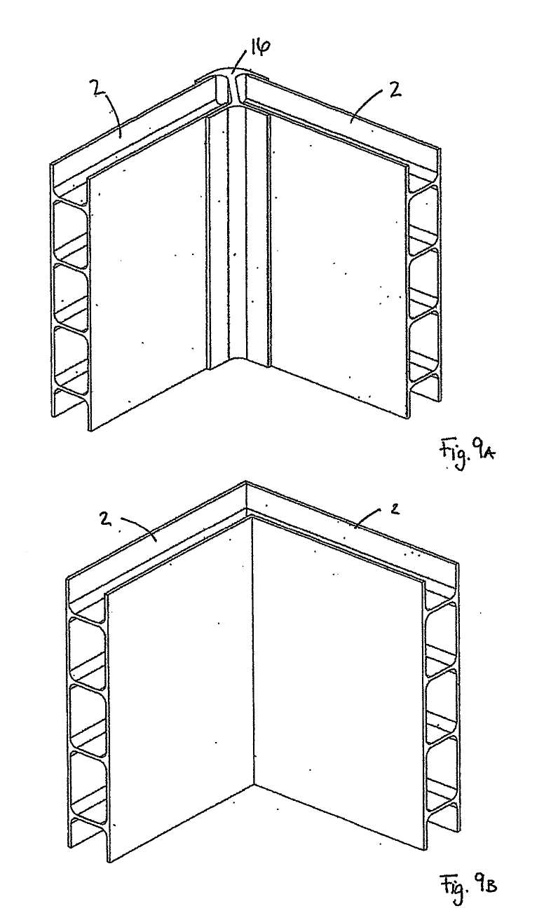

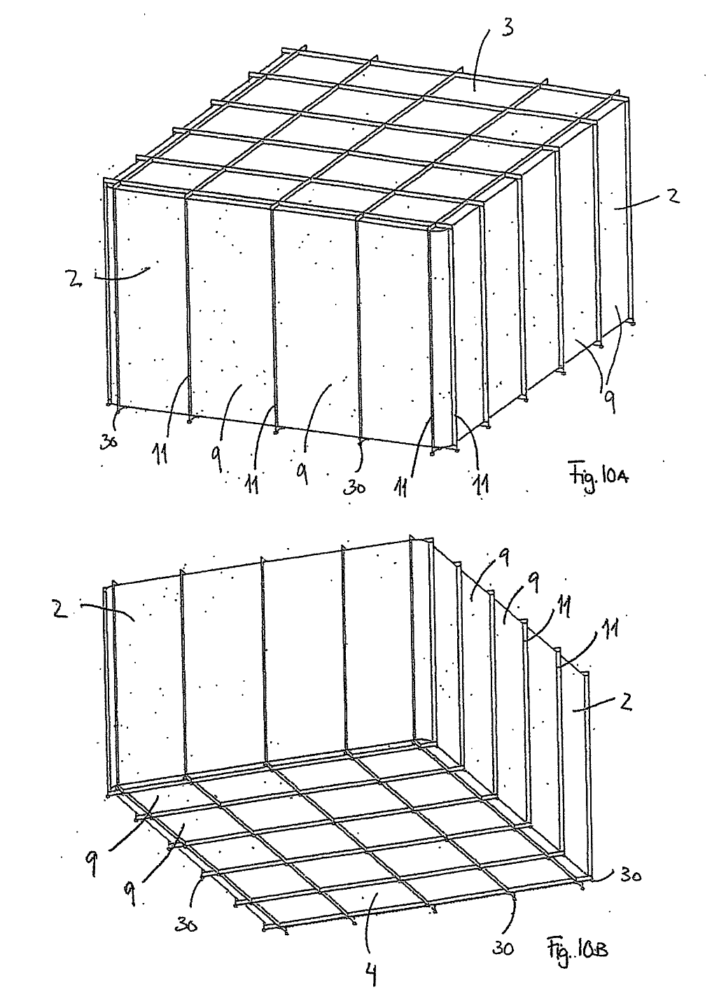

FIG. 10A-B show two perspective views of a tank according to the invention with the outer skin of the sandwich removed,

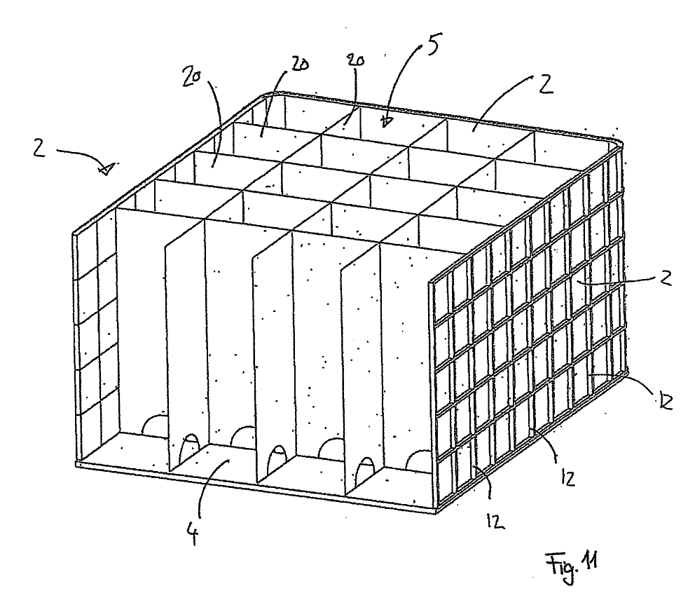

FIG. 11 shows a tank according to the invention with external stiffeners, with the roof and one side wall removed,

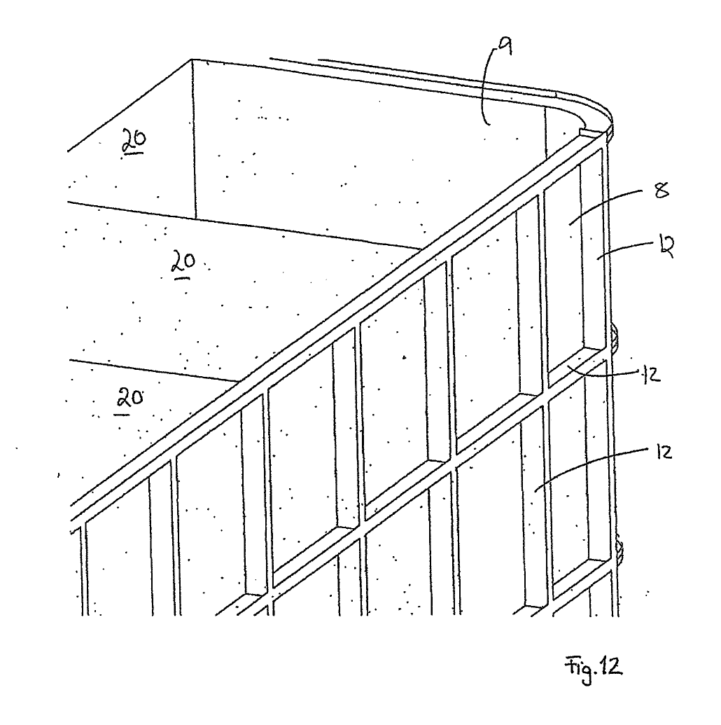

FIG. 12 shows a detail of a part of the tank in FIG. 8.

The tank 1 according to the invention comprises side walls, roof and floor in the form of external plates and an internal cell wall structure, whereof there in FIG. 1 is shown three side walls 2, a bottom plate 4 and an internal cellular wall structure 5, dividing the internal void of the tank 1 into smaller cells. It is possible to envisage several different structures forming the walls, roof and floor and their connecting zones. These may all be of similar or different constructions. The internal cellular wall structure may also be envisaged constructed in several ways. Different embodiments of these elements will be described below.

The internal cell walls 20, forming the internal cellular wall structure 5 in the form of plates with a smooth surface, have passage openings 6 at the level of the bottom plate 4 with possible edge beams, to give internal communication between all the different cells. This also gives access between the cells for inspection and repair in the case of a larger tank. The tank will also comprise an emptying and filling system and other detection and monitoring systems and support means which are not shown in the figure.

FIG. 2 shows a different embodiment of the tank 1 with side walls 2 and a cellular structure 5 comprising of cell walls 20, where the four corner cells outer walls are fully rounded in an arc in comparison with FIG. 1 where they are shown as only partly rounded with a straight part at each end as well. FIG. 3 shows an alternative tank 1 with side walls 2 and an internal cellular wall structure 5 of internal cells wall 20, where the corners of the side walls are right angled.

FIG. 4A shows a perspective view of a detail of the tank in FIG. 1, showing an embodiment where the side walls 2 are formed as a sandwich structure with an outer surface sheet 8 and an inner surface sheet 9 where between there is a core material 10. The sandwich structure also comprises stiffeners 11. These stiffeners 11 may have several forms but preferably they stretch from one surface sheet of the sandwich structure to the other surface sheet of the sandwich structure. In the preferred embodiment the stiffeners are plate like elements which width is substantially equal to the distance between the surface sheets in the sandwich structure and where the length of the plate element run in the vertical direction of the side wall, and preferably for the whole height of the side wall. In this figure the internal cellular wall structure 5 is shown as in a first embodiment of the cell wall structure, where the cell walls 20 are formed with single plate walls, which are joined at intersections 21. The cell walls 20 are preferably anchored to the side wall 2 at the point where the sandwich structure have plate like stiffeners 11, by for instance welding between the cell wall 20 and the internal surface skin 9 of the sandwich structure. This is favourable in relation to transferral of loads between the external walls and the internal cellular structure. The cell walls 20 may also be formed with a pattern of through going holes (not shown in any figures).

In FIG. 4B there is shown a second embodiment of an internal cellular wall structure. In this embodiment the cell walls 20 are formed by a plurality of beam elements 28 arranged above each other forming a cell wall 20. The beams 28 are arranged with one set of beams 28A in a first layer and a second layer of beams 28B above this first layer are arranged with their longitudinal axis across the beams 28A in the first layer. In a third layer the beams 28A are arranged mainly parallel with the beams in the first layer. This forms a lattice structure with several layers and with beams with different longitudinal axes in different layers. This gives a cell wall 20 formed by beam elements with spaces between each beam element in cell wall 20. This gives the necessary communication between the cells and at the same time the necessary prevention against sloshing in a tank positioned on a moving vessel. At the intersection 21 of the cell walls 20 the beam elements 28A, 28B are arranged abutting one on top of the other beam element forming support for each layer of beam elements 28A, 28B and also a transferring point for eventual loads from roof to floor.

The beam elements 28A, 28B may be plane plates, or have a I of T or H formed cross section. By having a cross section with end flanges as in a I, T or H formed or even tubular rectangular or rectangular, cross section one also achieves a more stable construction of the internal cellular wall structure since a beam in one layer may lay with its end flanges in abutment against the end flanges of the beams in the next layer. The beams may also be welded or mechanically fixed to each other to form an even more stable construction of the internal cellular wall structure. To stabilise the construction one could also between the beams arrange a plurality of strength elements. The strength elements can be placed randomly or in a particular pattern. One beam element in the cell wall structure may reach from one external wall to the opposite external wall, i.e. the beam elements form a part of several cell walls.

The cell walls 20 may be smooth plate elements as shown in the embodiment in FIG. 4A, plate elements with stiffening means (not shown in any figure), formed by a plurality of beam elements or even plates with corrugations 23 as shown in FIG. 5A. These plates have corrugations 23 running in a mainly horizontal direction.

The internal cellular structure 5 comprises cell walls 20 which meet at intersections 21. These intersections 21 may in a preferred embodiment comprise at least one stiffening member 24. The stiffening member 24 may be wholly or partly tubular (circular, square) or comprising main elements positioned in a right angle relative to each other, and abutting the surface sides of two adjacent cell walls, as shown in FIG. 5A. There may be stiffening members 24 only in one corner of the intersection of the cell walls 20, or there may be stiffeners at more than one corner or all the corners.

According to the invention the internal cellular structure 5 is anchored to the external walls of the tank, this may be done in several ways. One is as shown in FIG. 4A where the cell walls 20 are joined with the inner surface sheet 9 of the sandwich structure at the position of the stiffeners. This gives a transferral of loads through the sandwich structure and out to the outer sheet 8 of the sandwich structure.

Another possibility is shown in FIG. 5A where a fastening element 14 is arranged in the sandwich structure, this also gives a transferral of loads to the outer part of the sandwich structure in the external walls. Another possibility is just to weld the cell walls 20 to the inner sheet 9 of the sandwich structure (not shown).

Other embodiments especially suitable for cell wall structure comprising beam elements are shown in FIG. 5B-E, these solutions will also be usable for connection of cell wall structures formed by smooth plates or corrugated plate.

In FIG. 5B it is shown that the beam elements 28A, are attached to a flange 40′ which is attached to the side wall 2, and protruding into the void of the tank in a direction transverse to the external wall. The flange 40′ is shaped with a larger protruding part by the connection to a beam element 28A, and a less protruding part between the beam elements 28A.

In FIG. 5C-E where the cell wall 20 is shown as formed by several beam elements 28A, these beam elements 28A are attached to a side wall 2, comprising of two elements 2A and 2B joined by a connection element 40. The connection element 40 shown in FIG. 5C-E is formed with a mainly U-shaped groove for insertion of the respective elements 2A, 2B.

The connection element 40 is further formed with a flange 45 extending into the void of the tank in a direction transverse to the side wall 2. The internal cellular wall structure 5, by the beam elements 28A are attached to this flange 45 in several ways. One embodiment is shown in FIG. 5C where the beam elements 28A are welded to the flange 45. Another embodiment is shown in FIG. 5D where the beam elements 28A is attached to the flange 45 through a connection piece 41 with two U-shaped grooves for position of a part of the beam elements 28A and a part of the flange 45 and connected to these elements by through going bolts through bolt holes 42. In FIG. 5E the beam elements are each formed with a U-shaped groove for insertion of the flange 45, which forms a third embodiment, and connected by for instance welding.

In FIG. 5F-G it is shown that the beam elements 28A, 28B are attached to knee-joints 40″, which are attached to an external wall 2, the knee-joint protruding into the void of the tank in a direction longitudinal to the external wall 2. In fig. the beam elements 28A, 28B are of I-section, whereupon there on each flange of the beam is attached a knee-joint 40″. The beam elements 28A, that form the internal cell structure, can be attached to the knee-joint 40″ in several ways, e.g. by welding, bolts etc. The knee-joints 40″ can in equivalent ways be attached to the external wall 2.

FIG. 6A-B and 7A-B show two different embodiments of a cell wall 20 formed with end part elements 25, 25′ which cooperate with other end part elements 25, 25′ to form a stiffening member 24, at an intersection in the internal cellular structure 5.

In FIG. 6A there is shown a cross section of a cell wall 20. There is to both ends of the cell wall attached end part elements 25, 25′ which are longitudinal and have L-shaped cross sections.

The end part element 25, 25′ are attached to the cell wall 20 at respective points on the raised part 26 of the L-shape and the lower part 27 is facing away from the cell wall. As can be seen from FIG. 6A the lower parts 27, 27′ of the two end part elements 25, 25′ are preferably positioned on opposing sides of the cell wall 20.

FIG. 6B shows a cross section of an intersection of four cell walls 20, with an embodiment as described in relation to FIG. 6A. The end part elements 25, 25′, each with an L-shape form with a raised part 26, 26′ and a lower part 27, 27′, of all four cell walls interact at the intersection and forms together a stiffening member 24. The raised part 26 of one end part element 25 is connected to a lower part 27 of another end part element 25 and all four together forms a rectangular element. The L-shaped elements may be connected by welding, screws, bolts, pop rivets or equal.

FIG. 7A-B show another embodiment, where in FIG. 7A it is shown a cell wall 20′ with a respective end part element 25′ with a V-shape, attached to both ends of the cell wall 20′.

In FIG. 7B it is shown a cross section of four cell wall similar to the one shown in FIG. 7A, forming an intersection where the four end part elements 25′ form a stiffening member 24′.

The outer plates of the tank 1, the roof, side walls and floor comprises according to the invention are preferably a sandwich structure comprising an outer surface sheet 8 and an inner surface sheet 9 with a core between them, the core being a continuous material as shown in FIG. 8A or a structure as shown in FIG. 8B-C. The core provides for at least partly the strength of the wall and the insulation of the tank. The sandwich structure may comprise a structure or stiffeners 11 between the outer and inner surface sheet, 8 and 9 respectively. These may have different forms shown in the FIG. 8A-C, wherein in FIG. 8A they are straight transverse stiffeners, straight stiffeners arranged with an angle other than 90 degrees with respect to the surface of the sheets 8, 9 in FIG. 8B or a solution where the surface sheets 8, 9 and the stiffeners are extruded in one piece. There may of course also be a continuous material between the structure of stiffeners as shown in FIG. 8A.

In another embodiment as shown in FIG. 8D the sandwich structure may comprise in addition external stiffeners 12, protruding outward from the side, top or bottom plates and an outer insulation layer 13. The external stiffeners 12 may protrude partly through the outer insulation layer 13, as shown, or fully through the outer insulation layer. As shown in FIG. 8D there may be a connection between the cell walls 20 in the internal cellular structure 5, the stiffeners 11 in the sandwich structure and the external stiffeners 12, or the stiffeners 11 and the external stiffeners 12 may form part of an elongation of the cell wall 20. The stiffeners may be provided with cut-outs, recesses or other insulating material element to reduce the heat transfer through the stiffeners.

Examples of corner solutions for joining the external walls 2 are shown in FIG. 9A-B. In the solution shown in FIG. 9A there is a corner element 16, formed with mainly U-shaped grooves for insertion of external wall segments and welded to the corner element 16. In the solution shown in FIG. 9B the outer sheets of the sandwich structure of the external wall 2 is joined together by welding directly to each other forming a sharp angle.

In FIG. 10A and 10B there are shown perspective views of a tank according to the invention with the outer surface sheet 8 of the sandwich structure and core material removed, showing the inner surface sheet 9 and the plate like stiffeners 11, running in a grid patter in the top 3 and bottom plates 4 and in a direction running from the bottom 4 to the roof 3 in the side wall 2. There are also arranged support means 30 at all the ends and intersection of the stiffeners 11 for the bottom plate 4. These will be explained in more detail later.

FIG. 11 shows a tank according to the invention with a side wall and the roof removed, and FIG. 12 a detail of the tank in FIG. 10. The side walls 2 of the tank comprise in this embodiment external stiffeners 12 running in a grid structure, with stiffeners 12 running in a mainly horizontal and vertical direction. One may see from these figures that the cell walls 20 of the internal cellular structure 5 are connected to the side walls 2 along the position of an external stiffener 12, this gives beneficial structural integrity of the tank. Provided the stiffener system is designed with sufficient strength this embodiment of the invention does not require structural strength in the insulation layer.

In one embodiment of the invention the external plates may be connected to and supported by other existing, adjacently located, structural systems at one or several point or along line contact areas by way of elastic links, linear or nonlinear mechanical devices, or pneumatic and or hydraulic devices or combination thereby. This is not shown in any figure. One specific embodiment is to use the previous described support means to support a side wall of the tank, however there may be envisaged a lot of other embodiments, as indicated above. The beam structure forming the cell walls may be formed by closed profiles having a tubular or rectangular cross section.

The invention has now been explained with different detailed embodiments. However, it is possible to envisage a lot of alterations and modifications to these embodiments within the scope of the invention as defined in the following claims. The cell structure may have different geometries. The outer structure may be laterally supported by surrounding structures as for instance a ship. There may be several layers of insulation with different quality and this may be varied for the different plates forming the tank. The support means may be positioned for supporting the tank laterally, or the may be other outer lateral support as for example an outer structure as the hull of a ship.

1. A tank (1) for storing of fluid at especially low temperatures, the tank comprising a double wall sandwich structure comprising an internal surface sheet (9) and an external surface sheet (8), which double wall sandwich structure forms at least part of a roof (3), side walls (2) and a floor (4) of the tank and is connected with an internal cellular structural system (5) within the tank itself, characterised in that, the tank wall structure is anchored by the internal cellular structural system (5), where the external surface sheet (8) of the double wall sandwich structure is either connected directly to the internal cellular structural system (5) by way of fixing arrangements or connected indirectly by way of connection elements (40, 40′) or internal stiffeners (11), the tension being transferable from the tank side wall structure (2) to the internal cellular structural system (5) by way of anchoring or fixing arrangements.

2. A tank (1) for storing of fluid at especially low temperatures, the tank comprising a double wall sandwich structure comprising an internal surface sheet (9) and an external surface sheet (8), which double wall sandwich structure forms at least part of a roof (3), side walls (2) and a floor (4) of the tank and is connected with an internal cellular structural system (5) within the tank itself, characterised in that, the tank wall structure is anchored by the internal cellular structural system (5), as at least a part of the structural system (5) comprises a layered arrangement (28A, 28B), where the external surface sheet (8) of the double wall sandwich structure is either connected directly to the internal cellular structural system (5) by way of fixing arrangements or connected indirectly by way of connection elements (40, 40′) or internal stiffeners (11), the tension being transferable from the tank side wall structure (2) to the internal cellular structural system (5) by way of anchoring or fixing arrangements.

3. A tank (1) according to claim 1, wherein the internal surface sheet (9) and the external surface sheet (8) of the double wall sandwich structure (2) are connected to the internal cellular structural system (5) by way of the anchoring or fixing arrangements.

4. A tank (1) according to any one of the previous claims, wherein the double wall sandwich structure comprises a core between the internal surface sheet (9) and the external surface sheet (8) forming the sandwich structure, the core being capable of transferring loads between the internal surface sheet (9) and the external surface sheet (8).

5. A tank (1) according to claim 4, wherein the core comprises at least one stiffening member (11) extending between the internal surface sheet (9) and the external surface sheet (8).

6. A tank (1) according to claim 5, wherein the stiffening member (11) is attached to the internal cellular structural system (5) such that, in use, there is a transfer of loads between the external surface sheet (8) and the internal surface sheet (9) via the stiffening member.

7. A tank (1) according to claim 6, wherein the anchoring or fixing arrangements of the internal cellular structural system (5) are disposed adjacent respective stiffening members (11, 12) disposed within or connected to the double wall sandwich structure, the arrangement being such that, in use, loads are transferred between the double wall structure (2) and the internal cellular structural system (5) via the anchoring or fixing arrangements and the stiffening member (11).

8. A tank (1) according to any one of the previous claims, wherein the anchoring or fixing arrangements comprise a flange bracket (40, 41)arrangement connecting the internal cellular structural system (5) to the double wall sandwich structure (2).

9. A tank (1) according to any one of the previous claims, wherein the internal cellular structural (5) system comprises walls formed by beam elements (28A, 28B) layered on top of each other in a crossing configuration forming a lattice, the beams in one layer having one orientation and the beams in a next layer having another orientation and forming openings between the beams.

10. A tank (1) according to any one of claims 1 to 8, wherein that the internal cellular structural system walls (5) are formed by plate elements.

11. A tank (1) according to any one of the preceding claims, wherein the internal cellular structural system (5) comprises at least one intersection(s) (21) between the elements forming the cellular structure (5).

12. A tank (1) according to claim 11, wherein each intersection (21) extends the entire height of the internal cellular structural system (5) and the intersections (21) are adapted to carry the weight of the cellular walls and the roof (3) of the tank.

13. A tank (1) according to claims 11 or 12, wherein each intersection (21) comprises at least one stiffening member (24) arranged abutting the surface side of two adjacent cellular structure walls.

14. A tank (1) according to claim 13, wherein the stiffening member is formed by cooperative end part elements (25, 26, 27) connected to the ends of at least some of the cellular walls intersecting at the intersection.

15. A tank (1) according to any one of the preceding claims, wherein the double wall sandwich structure comprises separate fastening members (40, 41) or connection elements for anchoring the double wall sandwich structure to the internal cellular structural system (5).

16. A tank (1) according to any one of the preceding claims, wherein the double wall sandwich structure comprises an outer insulation layer disposed on an outer surface of the external surface sheet (8).

17. A tank (1) according to any one of the preceding claims, wherein the double wall sandwich structure is connected to and is supported by other existing, adjacently located, structural systems at one or several points or along line contact areas by way of elastic links, linear or nonlinear mechanical devices, or pneumatic and or hydraulic devices or combination thereby.

18. An internal structural system (5) for strengthening and supporting a double wall sandwich tank comprising a roof, side walls and a floor, the tank being suitable for storing of fluids, particularly at very low temperatures, the internal structural system (5) comprising tension beams (28A, 28B) adapted to span between opposite walls of the tank (1) and being connectable to the walls (2) of the tank (1), characterised in that, the tension beams (28A, 28B) are disposed in a staggered arrangement and form a cellular pattern inside the tank (1) such that the beams (28A) in one direction rest upon the beams (28B) in the other direction in a horizontal layer by layer arrangement from the floor (4) to the roof (3) of the tank (1), the arrangement being such that, in use, the tank wall (2) structure is anchored by the internal cellular system (20) under a self equilibrating tension arrangement whereby fluid pressure on the tank wall (2) is transferred from the tank wall (2) to the internal cellular structural system (20).

19. An internal structural system (5) according to claim 18, wherein in use the tank (1) wall structure (2) is anchored by the internal structural system under direct, self-equilibrium tension from a fluid pressure acting on opposite walls (2) of the tank, the tension load being transferred to the internal structural system (5) via anchoring or fixing arrangements (40, 40′).

20. An internal structural system (5) according to claim 18 or claim 19, wherein the beam elements (28A) in one layer are arranged with mainly parallel longitudinal axis, where a plane of beams in a layer next to the first one comprises beams (28B) with their longitudinal axis substantially transverse to the beams (28A) in the first layer, and this layering is repeated to form cellular walls (20), wherein the beams (28A) in the first layer forms part of a first cellular wall (20) and the beams (28B) in the second layer forms part of a second cellular wall (20) substantially transverse to the first cellular wall and meeting at an intersection (21).

21. An internal structural system (5) according to any one of claims 18 to 20, wherein the beam elements (28A, 28B) have a T- or I- formed cross section.

22. An internal structural system (5) according to claim 20, wherein the beam elements (28A, 28B) are adapted to be connected directly or indirectly to an external surface sheet (8) of the tank (1) by way of anchoring or fixing arrangements, the arrangement being such that, in use, loads are transferred between the external surface sheet (8) of the tank (1) and the internal structural system (5).
